(19) United States
(12) Patent Application Publication
(10) Pub. No.: US 2026/0061419 A1
(43) Pub. Date: Mar. 5, 2026

(54) THIN FILM, DIGITAL MICROFLUIDIC CHIP SUBSTRATE AND PREPARATION METHOD THEREFOR

(71) Applicant: JIANGSU LOGILET BIOTECH CO., LTD., Suzhou, Jiangsu (CN)

(72) Inventor: Yang SU, Suzhou, Jiangsu (CN)

(21) Appl. No.: 19/103,219

(22) PCT Filed: Aug. 11, 2023
(86) PCT No.: PCT/CN2023/112714

§ 371 Date: Feb. 11, 2025

(30) Foreign Application Priority Data
Aug. 12, 2022 (CN) 202210969277.X

(51) Int. Cl. B01L 3/00

(52) U.S. Cl. CPC B01L 3/502707; B01L 2300/0887; B01L 2300/165

(57) ABSTRACT

A thin film, a digital microfluidic chip substrate, and a preparation method therefor. The thin film (3) is a dielectric and hydrophobic thin film, one surface of the dielectric and hydrophobic thin film being a hydrophilic surface, and the other surface of the dielectric and hydrophobic thin film being a hydrophobic surface. The thin film (3) has both dielectric and hydrophobic functions, thus radically overcoming the irreversible damage to traditional digital microfluidic chips caused by hydrophobic layers thereof falling off from dielectric layers, and greatly simplifying the preparation process for dielectric and hydrophobic layers. Meanwhile, the thin film is resistant to high temperature and does not easily fall off from the circuit substrate (1), thereby widening the use scenarios of a chip, and prolonging the service life of the chip.

The present application claims the priority of the Chinese Patent Application No. CN 202210969277.X, filed on 12 Aug. 2022, the content of which is considered as a part of the present application and is incorporated herein in its entirety.

### TECHNICAL FIELD

The present application belongs to the technical field of digital microfluidic chips, and in particular relates to a thin film, a digital microfluidic chip substrate, and preparation methods therefor.

### BACKGROUND ART

A digital microfluidic chip is on the basis of electrowetting technology, which regulates the surface energy of solid and liquid through electric potential and generates a tangential thrust by virtue of the asymmetry of the contact angles of a droplet, leading to an asymmetric deformation at both ends of the droplet and promoting a pressure difference within the droplet, thereby achieving precise manipulation of microdroplets. The basic structure of the digital microfluidic chip includes a circuit substrate, and a dielectric layer and a hydrophobic layer provided on the circuit substrate, which together constitute a chip substrate. The dielectric layer and hydrophobic layer on the circuit substrate are the most critical structures of a digital microfluidic chip, and their dielectric and hydrophobic properties are critical for liquid manipulation.

Currently, the most important technique for preparing a digital microfluidic chip substrate includes first forming a dielectric layer material on a printed circuit board (PCB)-based circuit substrate by a coating process, and then forming a hydrophobic layer on the dielectric layer by a process such as spin coating or spray coating. The conventional preparation process is complicated, the dielectric film material suitable for a coating process has a thickness too large to provide a sufficient driving force for liquid, and the preparation of a hydrophobic layer requires high cleanliness of the equipment and environment, leading to high economic costs; moreover, the hydrophobic layer falls off from the dielectric layer easily, causing irreversible damage to digital microfluidic chips.

### SUMMARY OF THE INVENTION

In order to overcome the deficiencies in the prior art, after long-term exploration and continuous attempts, the inventor provides a thin film, a digital microfluidic chip substrate, and preparation methods therefor. The thin film of the present application achieves the dual function of a dielectric layer and a hydrophobic layer, which radically solves the problem of easy fall-off of a hydrophobic layer from a dielectric layer. Additionally, the dielectric and hydrophobic thin film of the present application has a hydrophilic surface that is conducive to bonding with an adhesive, such that the thin film can be firmly affixed to the upper surface of a circuit substrate, and has the effect of resistance high temperature and not easily falling off from the circuit substrate, thereby widening the use scenarios of a chip, and prolonging the service life of the chip.

In a first aspect, the present application provides a thin film, which is a dielectric and hydrophobic thin film, one surface of the dielectric and hydrophobic thin film being a hydrophilic surface and the other being a hydrophobic surface.

In a second aspect, the present application provides a digital microfluidic chip substrate, comprising a circuit substrate, an adhesive, and the thin film according to the present application.

In a third aspect, the present application provides a method for preparing the thin film according to the present application, the method comprising subjecting the thin film to surface modification treatment.

In a fourth aspect, the present application provides a method for preparing the digital microfluidic chip substrate according to the present application, the method comprising:
(1) applying the adhesive to a surface of the circuit substrate;
(2) covering the surface of the adhesive with the hydrophilic surface of the thin film.

In a fifth aspect, the present application provides the use of the thin film according to the present application as a substitute for a dielectric layer and a hydrophobic layer in the preparation of a digital microfluidic chip.

In a sixth aspect, the present application provides a digital microfluidic chip, comprising the thin film according to the present application or the digital microfluidic chip substrate according to the present application.

In a seventh aspect, the present application provides a digital microfluidic system, comprising the thin film according to the present application, or the digital microfluidic chip substrate according to the present application, or the digital microfluidic chip according to the present application.

Compared with the prior art, the present application has the following beneficial effects.

The thin film according to the present application has the dual function of both a dielectric layer and a hydrophobic layer in a conventional process, thereby radically solving the problem of irreversible damage to digital microfluidic chips caused by the easy fall-off of the hydrophobic layer from the dielectric layer while greatly simplifying the preparation process, reducing the production costs and improving the production efficiency. Additionally, compared to the film thickness of a conventional dielectric layer, the thin film of the present application has a smaller thickness, which not only provides a greater driving force, but also does not have the problem of easy breakdown by high voltage due to the smaller thickness. Furthermore, the thin film according to the present application also has a hydrophilic surface, and after the hydrophilic surface is bonded to the adhesive, the thin film can be firmly affixed to the upper surface of a circuit substrate and has the effect of resistance to a high temperature of up to 100° C. and not easily falling off from the circuit substrate, thus greatly widening the use scenarios of a chip and prolonging the service life of the chip.

### BRIEF DESCRIPTION OF THE DRAWINGS

FIG. 1 shows a schematic diagram of the preparation of a digital microfluidic chip substrate according to the present application.

Here, 1—circuit substrate; 2—adhesive; and 3—thin film.

### DETAILED DESCRIPTION OF EMBODIMENTS

Unless otherwise stated, all numbers representing content, concentration, ratio, mass, percentage, technical effect, and so forth as used in the description and claims should be understood as being modified in any case by the term “about” or “approximately”. Therefore, unless indicated to the contrary, numerical parameters as set forth in the following description and appended claims are approximations. Unless otherwise stated, the terms used herein have a meaning commonly understood by those skilled in the art. For those skilled in the art, each numerical parameter may vary depending upon the desired properties and effects sought to be obtained by the present application and should be construed in light of the number of significant digits and conventional rounding techniques or in a manner understood by those skilled in the art.

Although the broad range of the numerical values and the parameters are set forth as approximations in the present application, the numerical values as set forth in the specific examples are given as precisely as possible. However, any numerical value inherently contains certain errors, which are inevitably caused by the standard deviation found in their respective test measurements. Each numerical range given in the present description will include every narrower numerical range that falls within such a broader numerical range, as if such narrower numerical ranges are all expressly written herein.

Unless otherwise stated, the orientation or position relationships indicated by the terms used in the description and claims, such as “center”, “longitudinal”, “transverse”, “up”, “down”, “front”, “rear”, “left”, “right”, “vertical”, “horizontal”, “top”, “bottom”, “inside” and “outside”, are based on the orientation or position relationships shown in the drawings and are merely for ease of description of the present application and for simplicity of the description, rather than indicating or implying that the device or element referred to must have a specific orientation or be constructed and operated in a specific orientation, and thus cannot be construed as a limitation on the present application. In addition, the terms “first”, “second” and the like are used for descriptive purposes only, and cannot be construed as indicating or implying relative importance or implicitly indicating the number of technical features indicated. Thus, the features defined with “first”, “second” and the like may explicitly or implicitly include one or more features. In the description of the present application, unless otherwise stated, “a plurality of” means two or more.

In the present application, the expression “contact angle” refers to an angle, at the point where the three phases of solid, liquid and vapor meet, starting from the solid-liquid interface, passing through the inside of the liquid and ending at the gas-liquid interface, which is an important parameter to characterize the wettability of the surface of a material. A contact angle equal to 0 indicates complete wetting; a contact angle less than 90° indicates partial wetting; a contact angle equal to 90° is a dividing line between “wetting” and “non-wetting”; a contact angle greater than 90° indicates non-wetting; and a contact angle equal to 180° indicates complete unwettability. The contact angle of the thin film of the present application is measured with a contact angle measuring instrument using an image analysis method.

In the present application, the expression “sliding angle” refers to a critical angle formed between a tilted surface and the horizontal plane before a droplet begins to roll off the tilted surface. The sliding angle is an important parameter to characterize the wettability of the surface of a material. The sliding angle of the thin film of the present application is measured with a sliding angle measuring instrument using an image analysis method.

In a first aspect of the present application, there is provided a thin film, which is a dielectric and hydrophobic thin film, one surface of the dielectric and hydrophobic thin film being a hydrophilic surface and the other being a hydrophobic surface.

In some embodiments of the present application, the thin film is a single-layered film.

The thin film provided by the present application realizes the dual function of a dielectric layer and a hydrophobic layer in conventional processes, thus radically solving the problem of irreversible damage to a digital microfluidic chip caused by the easy fall-off of the hydrophobic layer from the dielectric layer. Moreover, the thin film provided by the present application has stable performance, good chemical and biological compatibility, and good application prospects in the biochemical field. Additionally, the thin film provided by the present application has a hydrophilic surface, and after the hydrophilic surface is bonded with the adhesive, the thin film can be firmly affixed to the upper surface of a circuit substrate and does not easily fall off from the circuit substrate, thus greatly prolonging the service life of chips.

In some embodiments of the present application, the hydrophilic surface of the thin film has a contact angle of <90°.

In some embodiments of the present application, the hydrophilic surface of the thin film has a contact angle of ≤80°. In some embodiments of the present application, the hydrophilic surface of the thin film has a contact angle of ≤70°. In some embodiments of the present application, the hydrophilic surface of the thin film has a contact angle of ≤60°. In some embodiments of the present application, the hydrophilic surface of the thin film has a contact angle of ≤50°. In some embodiments of the present application, the hydrophilic surface of the thin film has a contact angle of ≤40°. In some embodiments of the present application, the hydrophilic surface of the thin film has a contact angle of ≤30°. In some embodiments of the present application, the hydrophilic surface of the thin film has a contact angle of ≤20°. In some embodiments of the present application, the hydrophilic surface of the thin film has a contact angle of ≤10°. In some embodiments of the present application, the hydrophilic surface of the thin film has a contact angle of 70°, 71°, 72°, 73°, 74° or 75°.

In some embodiments of the present application, the hydrophilic surface of the thin film has a sliding angle of ≥30°.

In some embodiments of the present application, the hydrophilic surface of the thin film has a sliding angle of 30°, 31°, 32°, 34° or 35°.

In some embodiments of the present application, the hydrophilic surface of the thin film has a sliding angle of ≥40°. In some embodiments of the present application, the hydrophilic surface of the thin film has a sliding angle of ≥50°. In some embodiments of the present application, the hydrophilic surface of the thin film has a sliding angle of ≥55°. In some embodiments of the present application, the hydrophilic surface of the thin film has a sliding angle of ≥60°. In some embodiments of the present application, the hydrophilic surface of the thin film has a sliding angle of ≥65°. In some embodiments of the present application, the hydrophilic surface of the thin film has a sliding angle of ≥70°.

In some embodiments of the present application, the dielectric and hydrophobic thin film is a Teflon thin film.

In some embodiments of the present application, the thin film is an amorphous fluoropolymer thin film (AF), a fluorinated ethylene propylene resin thin film (FEP), a fluoropolymer foam resin thin film (FFR), a fluoropolymer resin thin film (NXT), or a perfluoroalkoxy resin thin film (PFA).

In some embodiments of the present application, the thin film is a fluorinated ethylene propylene resin thin film (FEP), or a perfluoroalkoxy resin thin film (PFA).

In some embodiments of the present application, the thin film is a fluorinated ethylene propylene resin thin film (FEP). In some embodiments of the present application, the thin film is a perfluoroalkoxy resin thin film (PFA).

In some embodiments of the present application, the thin film has a thickness of 5-200 μm.

In some embodiments of the present application, the thin film has a thickness of 5-150 μm.

In some embodiments of the present application, the thin film has a thickness of 10-100 μm. In some embodiments of the present application, the thin film has a thickness of 10-90 μm. In some embodiments of the present application, the thin film has a thickness of 10-80 μm. In some embodiments of the present application, the thin film has a thickness of 10-70 μm. In some embodiments of the present application, the thin film has a thickness of 10-60 μm. In some embodiments of the present application, the thin film has a thickness of 10-50 μm. In some embodiments of the present application, the thin film has a thickness of 10-40 μm. In some embodiments of the present application, the thin film has a thickness of 10-30 μm. In some embodiments of the application, the thin film has a thickness of 10 μm, 12 μm, 12.5 μm, 15 μm, 20 μm, 25 μm, or 30 μm. In some embodiments of the present application, the thin film has a thickness of 10-20 μm. In some embodiments of the present application, the thin film has a thickness of 12-18 μm. In some embodiments of the present application, the thin film has a thickness of 12-16 μm. In some embodiments of the present application, the thin film has a thickness of 12-14 μm. In some embodiments of the application, the thin film has a thickness of 12 μm, 12.5 μm, 13 μm, 13.5 μm, or 14 μm.

In some embodiments of the present application, the thin film has a thickness of 12.5-25 μm.

In some embodiments of the present application, the thin film has a thickness of 12.5 μm or 25 μm.

In order to provide sufficient driving force to the liquid, it is necessary to reduce the thicknesses of the dielectric layer and hydrophobic layer. However, in a conventional preparation process of a dielectric layer, in order to be suitable for a coating process, the thickness of a dielectric material cannot be too small; meanwhile, a dielectric layer with a too-low thickness is easy to break down under a high voltage, causing damage to the chip. The thin film of the present application not only has a film thickness much smaller than that of a dielectric layer prepared by a conventional process and thus can provide sufficient driving force to the liquid, but also has a higher breakdown voltage and is not easy to be broken down.

In a second aspect of the present application, there is provided a digital microfluidic chip substrate, comprising a circuit substrate, an adhesive, and the thin film according to the present application.

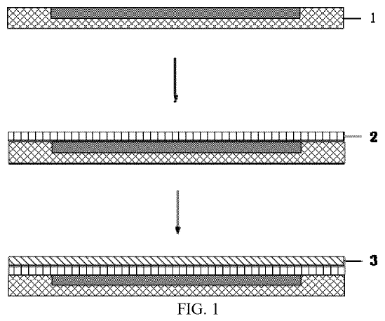

In some embodiments of the present application, with reference to FIG. 1, the chip substrate comprises the circuit substrate 1, the adhesive 2, and the thin film 3.

In some embodiments of the present application, the material of the circuit substrate is not particularly limited, and a circuit substrate commonly used in the art may be used. In some embodiments of the present application, the circuit substrate is a copper clad plate, a ceramic substrate, or an aluminum substrate.

In some embodiments of the present application, the circuit substrate and the thin film are bonded by the adhesive, and the adhesive is bonded to the hydrophilic surface of the thin film.

In some embodiments of the present application, the upper surface of the circuit substrate is coated with the adhesive, and the other surface of the adhesive is bonded to the hydrophilic surface of the thin film.

In some embodiments of the present application, the adhesive includes one or more of polyacrylic acid, polyurethane, epoxy resin, polyimide, polystyrene, polyacrylate, or ethylene-vinyl acetate copolymer. In some embodiments of the present application, the adhesive is one or more of polyacrylic acid, polyurethane or epoxy resin.

In some embodiments of the present application, the adhesive has a thickness of 1-50 μm. In some embodiments of the present application, the adhesive has a thickness of 5-40 μm. In some embodiments of the present application, the adhesive has a thickness of 5-30 μm. In some embodiments of the present application, the adhesive has a thickness of 5-25 μm. In some embodiments of the present application, the adhesive has a thickness of 5-20 μm. In some embodiments of the present application, the adhesive has a thickness of 5-15 μm. In some embodiments of the present application, the adhesive has a thickness of 5-10 μm.

In a third aspect of the present application, there is provided a method for preparing the thin film according to the present application, the method comprising subjecting the thin film to surface modification treatment.

In some embodiments of the present application, the thin film is subjected to surface modification treatment to obtain the hydrophilic surface, and the hydrophilic surface has a contact angle of <90°.

In some embodiments of the present application, the hydrophilic surface has a contact angle of ≤80°. In some embodiments of the present application, the hydrophilic surface has a contact angle of ≤70°. In some embodiments of the present application, the hydrophilic surface has a contact angle of ≤60°. In some embodiments of the present application, the hydrophilic surface has a contact angle of ≤50°. In some embodiments of the present application, the hydrophilic surface has a contact angle of ≤40°. In some embodiments of the present application, the hydrophilic surface has a contact angle of ≤30°. In some embodiments of the present application, the hydrophilic surface has a contact angle of ≤20°. In some embodiments of the present application, the hydrophilic surface has a contact angle of ≤10°. In some embodiments of the present application, the hydrophilic surface has a contact angle of 70°, 71°, 72°, 73°, 74° or 75°.

In some embodiments of the present application, the thin film is subjected to surface modification treatment to obtain the hydrophilic surface, and the hydrophilic surface has a sliding angle of ≥30°.

In some embodiments of the present application, the hydrophilic surface of the thin film has a sliding angle of 30°, 31°, 32°, 34° or 35°.

In some embodiments of the present application, the hydrophilic surface has a sliding angle of ≥40°, and in some embodiments of the present application, the hydrophilic surface has a sliding angle of ≥50°. In some embodiments of the present application, the hydrophilic surface has a sliding angle of ≥55°. In some embodiments of the present application, the hydrophilic surface has a sliding angle of ≥60°. In some embodiments of the present application, the hydrophilic surface has a sliding angle of ≥65°. In some embodiments of the present application, the hydrophilic surface has a sliding angle of ≥70°.

In some embodiments of the present application, the surface modification treatment is corona treatment, plasma treatment, chemical treatment, surface grafting treatment, or photochemical modification treatment.

In some embodiments of the present application, the surface modification treatment is corona treatment, plasma treatment or chemical treatment.

In some embodiments of the present application, the surface modification treatment is corona treatment. The corona treatment described in the present application is an electric shock treatment, which specifically involves using a corona treatment machine to perform corona discharge on the surface of a thin film with high frequency and high voltage, generating low-temperature plasma and enhancing the adhesion of the surface of the thin film.

In some embodiments of the present application, the plasma treatment is a low-temperature plasma treatment, which specifically involves ionizing a gas into a plasma state by applying sufficient energy to the gas, and then treating the surface of the thin film with low-temperature plasma.

In some embodiments of the present application, the chemical treatment may be chemical oxidation treatment, which specifically involves treating the thin film with an oxidant before use.

In some embodiments of the present application, the surface grafting treatment may involve forming a hydrophilic group on the surface of the thin film. In some embodiments of the present application, the surface grafting treatment may involve grafting hydrophilic molecules on the surface of the thin film.

In a fourth aspect of the present application, there is provided a method for preparing the digital microfluidic chip substrate according to the present application, the method including:
(1) applying the adhesive to a surface of the circuit substrate;
(2) covering the surface of the adhesive with the hydrophilic surface of the thin film.

In some embodiments of the present application, the method further comprises, in step (2), covering the hydrophobic surface of the thin film with a protective film.

In some embodiments of the present application, the method further comprises:
(3) processing the thin film on the surface of the circuit substrate in step (2) to obtain a desired shape;
(4) removing the protective film, so as to obtain the digital microfluidic chip substrate.

In some embodiments of the present application, the method further includes, in step (1), first cleaning a surface of the circuit substrate, and then applying the adhesive to the surface of the circuit substrate.

In some embodiments of the present application, the solvent for cleaning the surface of the circuit substrate is not particularly limited as long as there is no residue on the surface of the circuit board after cleaning. In some embodiments of the present application, the cleaning solvent includes one or more of isopropanol, ethanol, dimethylformamide, methylpyrrolidone, or dipropylene glycol dimethyl ether.

In some embodiments of the present application, in step (1), the coating process is a screen printing process. In some embodiments of the present application, in step (1), the coating process may also involve first spot-applying an adhesive to the surface of the circuit substrate, and then uniformly coating the adhesive on the surface of the circuit substrate by means of rolling.

In some embodiments of the present application, in step (2), first the hydrophobic surface of the thin film is covered with a protective film, and then the surface of the adhesive is covered with the hydrophilic surface of the thin film. In some embodiments of the present application, in step (2), first the surface of the adhesive is covered with the hydrophilic surface of the thin film, and then the hydrophobic surface of the thin film is covered with a protective film.

In some embodiments of the present application, the protective film is not particularly limited as long as it can provide the thin film with sufficient support to facilitate the subsequent operation of the thin film. In some embodiments of the present application, the protective film includes one or more of a polyethylene terephthalate film (PET film) or a polyvinyl chloride film (PVC film). In some embodiments of the present application, the protective film is a PET film.

In some embodiments of the present application, the order of step (2) and step (3) may be reversed. In some embodiments of the present application, it is possible to cover the hydrophobic surface of the thin film with a protective film, then process the thin film covered with the protective film to obtain the thin film having a target shape, and finally cover the surface of the adhesive with the hydrophilic surface of the thin film having the target shape.

In some embodiments of the present application, in step (3), the processing method is a method commonly used in the art for processing the thin film to obtain a target shape. In some embodiments of the present application, in step (3), the processing method is a laser engraving method, blanking method or die cutting method.

In some embodiments of the present application, in step (4), the protective film is removed after the adhesive is cured. In some embodiments of the present application, the curing time of the adhesive is 5-60 s. In some embodiments of the present application, the curing time of the adhesive is 10-50 s. In some embodiments of the present application, the curing time of the adhesive is 10-40 s. In some embodiments of the present application, the curing time of the adhesive is 10-30 s. In some embodiments of the present application, the curing time of the adhesive is 10-20 s. In some embodiments of the present application, the curing time of the adhesive is 15 s.

In a fifth aspect of the present application, there is provided the use of the thin film according to the present application as a substitute for a dielectric layer and a hydrophobic layer in the preparation of a digital microfluidic chip.

In a sixth aspect of the present application, there is provided a digital microfluidic chip, comprising the thin film according to the present application or the digital microfluidic chip substrate according to the present application.

In some embodiments of the present application, the digital microfluidic chip has a three-layered structure, specifically including an upper electrode plate, a lower electrode plate, and a cavity between the upper and lower electrode plates in which a test liquid can move, where the lower electrode plate includes a circuit substrate, a microelectrode array and the thin film according to the present application, and the filler between the upper and lower electrode plates may be air or silicone oil.

In some embodiments of the present application, the digital microfluidic chip adopts a coplanar electrode design, in which there is no upper electrode plate structure, both the positive and negative electrodes are disposed on a lower electrode plate, and the lower electrode plate comprises a circuit substrate, a microelectrode array, and the thin film according to the present application.

In a seventh aspect of the present application, the present application provides a digital microfluidic system, comprising the thin film according to the present application, or the digital microfluidic chip substrate according to the present application, or the digital microfluidic chip according to the present application.

In some embodiments of the present application, the digital microfluidic system may include a sample injection system, a nucleic acid extraction system, a detection system, a reaction system and the like, but is not limited thereto.

The above-mentioned various embodiments and preferences for the thin film, the digital microfluidic chip substrate, and the preparation methods therefor of the present application can be combined with one another (as long as they are not inherently contradictory to each other), and the various embodiments formed by the combination are considered as a part of the present disclosure.

The technical solutions of the present application will be described more clearly and explicitly below by way of illustration and in conjunction with examples. It should be understood that the examples are for illustrative purposes only and are not intended to limit the protection scope of the present application. The scope of protection of the present application is limited only by the claims.

### EXAMPLES

Unless otherwise stated, the raw materials and instruments used in the examples are conventional raw materials and instruments that are commercially available.

### Example 1: Preparation of FEP Thin Film 1

(1) The raw material of FEP particles was fed into a drying apparatus (STOLZ, CLK100), with the drying temperature set to 60° C., and the duration of the drying cycles set to 4 h;
(2) after drying, the raw material was fed into the hopper of a blown film apparatus (Windmöller & Hölscher, VAREX II) through a vacuum pipeline, followed by film blowing under conditions of a temperature of 260° C., a speed of 100 r/min, an air ring current of 4 A, and a cooling water temperature of 5° C. to obtain an FEP thin film with a thickness of 12.5 μm;
(3) one surface of the 12.5 μm FEP thin film was subjected to corona treatment using a corona apparatus (AcXys Technologies, ULD 500) under conditions of 15,000 V, 25 kHz, and an electrode gap of 1 mm to obtain an FEP thin film 1 with a hydrophilic surface; and
(4) the FEP thin film 1 was wound using a winding machine for later use.

### Example 2: Preparation of PFA Thin Film 2

(1) The raw material of PFA particles was fed into a drying apparatus (STOLZ, CLK100), with the drying temperature set to 60° C., and the duration of the drying cycles set to 4 h;
(2) after drying, the raw material was fed into the hopper of a blown film apparatus (Windmöller & Hölscher, VAREX II) through a vacuum pipeline, followed by film blowing under conditions of a temperature of 250° C., a speed of 100 r/min, an air ring current of 4 A, and a cooling water temperature of 5° C. to obtain a PFA thin film with a thickness of 12.5 μm;
(3) after film blowing, one surface of the 12.5 μm PFA thin film was subjected to corona treatment using a corona apparatus (AcXys Technologies, ULD 500) under conditions of 15,000 V, 25 kHz, and an electrode gap of 1 mm to obtain a PFA thin film 2 with a hydrophilic surface; and
(4) the PFA thin film 2 was wound using a winding machine for later use.

### Example 3: Preparation of FEP Thin Film 3

(1) The raw material of FEP particles was fed into a drying apparatus (STOLZ, CLK100), with the drying temperature set to 60° C., and the duration of the drying cycles set to 4 h;
(2) after drying, the raw material was fed into the hopper of a blown film apparatus (Windmöller & Hölscher, VAREX II) through a vacuum pipeline, followed by film blowing under conditions of a temperature of 260° C., a speed of 50 r/min, an air ring current of 4 A, and a cooling water temperature of 5° C. to obtain an FEP thin film with a thickness of 25 μm;
(3) one surface of the 25 μm FEP thin film was subjected to corona treatment using a corona apparatus (AcXys Technologies, ULD 500) under conditions of 15,000 V, 25 kHz, and an electrode gap of 1 mm to obtain an FEP thin film 3 with a hydrophilic surface; and
(4) the FEP thin film 3 was wound using a winding machine for later use.

### Example 4: Preparation of Chip Substrate 1

(1) The surface of a circuit substrate was cleaned using isopropanol;
(2) a surface of the circuit substrate in step (2) was uniformly coated with an adhesive by means of a screen printing process, where the adhesive was polyacrylic acid, and the printing thickness was 5-10 μm;
(3) the hydrophobic surface of the FEP thin film 1 was covered with a PET protective film;
(4) the circuit substrate printed with the adhesive in step (2) is smoothly covered with the hydrophilic surface of the thin film in step (3) by means of rolling;
(5) the product in step (4) was placed under a UV light source for 15 s to cure the adhesive;
(6) the FEP thin film 1 on the surface of the circuit substrate was exposed to laser to engrave a target shape; and
(7) the PET protective film on the hydrophobic surface of the FEP thin film 1 was removed, thus obtaining the chip substrate 1.

### Example 5: Preparation of Chip Substrate 2

The chip substrate 2 was prepared by the same method as that in Example 4, only except that the FEP thin film 1 in step (3) was replaced with the PFA thin film 2.

### Example 6: Preparation of Chip Substrate 3

The chip substrate 3 was prepared by the same method as that in Example 4, only except that the FEP thin film 1 in step (3) was replaced with the FEP thin film 3.

### Comparative Example 1

(1) A 25 μm KAPTON adhesive tape was affixed to a surface of a chip substrate as a dielectric layer;
(2) CYTOP was uniformly sprayed onto the upper surface of the KAPTON adhesive tape;
(3) the chip substrate was placed on a heating table, with the temperature set to 90° C. to vitrify the CYTOP;
(4) the chip substrate was cooled so that the CYTOP was solidified to form a hydrophobic layer, thus obtaining a conventional chip substrate with a dielectric layer and a hydrophobic layer; and
(5) the chip substrate in step (4) was made into a chip, which was then subjected to a pure water continuous movement test, 10 pieces of the chips were tested, and after 30 min of continuous movement of pure water, the partial fall-off of the hydrophobic layers from the dielectric layer occurred on 3 chips; meanwhile, 10 chips made from the chip substrate 1 with an FEP thin film having a hydrophilic surface in Example 4 were subjected to the pure water continuous movement test, with none of the 10 chips showing partial fall-off after 30 min of continuous movement of pure water. The specific operation of the pure water continuous movement test was as follows: the cavity of a chip was filled with silicone oil and then injected with 1 drop of 10 μL pure water droplet, and the electrodes were controlled and sequentially initiated, enabling the droplet to move back and forth in the cavity of the chip for 30 min.

### Comparative Example 2

The chip substrate of Comparative Example 2 was prepared by the same method as that in Example 4, only except that the FEP thin film 1 in step (3) was replaced with a 12.5 μm FEP thin film without hydrophilization treatment.

### Comparative Example 3

The chip substrate of Comparative Example 3 was prepared by the same method as that in Example 4, only except that the FEP thin film 1 in step (3) was replaced with a 12.5 μm PFA thin film without hydrophilization treatment.

### Performance Test

### 1. Parameter Measurement of Contact Angle of Thin Film

The contact angle of a thin film was measured using a contact angle measuring instrument (SINDIN, SDC-350) to characterize the hydrophilicity of the hydrophilic surface and the hydrophobicity of the hydrophobic surface of the thin film. 60 pieces of the thin films were tested, and the procedure of the test was as follows:
(1) a thin film was placed on a test platform;
(2) the measuring instrument was powered up, and 10 μm of pure water was dripped at a measurement position to start the test; and
(3) the measurement software ran automatically, outputting a contact angle value.

### 2. Measurement of Dielectric Constant of Thin Film

The dielectric constant of a thin film was measured by means of a three-terminal method using an impedance measuring instrument (Wayne Kerr, WK6500B), and the procedure of measurement was as follows:
(1) a thin film sample was clamped by a test fixture for clamping a dielectric material in a measuring instrument;
(2) the two electrodes of the measuring instrument were fixed on the test fixture to start the measurement; and
(3) the dielectric constant of the thin film was calculated by the software program of the impedance measuring instrument.

### 3. Measurement of Breakdown Voltage of Thin Film

The breakdown voltage of a thin film was measured using a voltage breakdown tester (Ainuo Instrument Co., Ltd., AN96), and the procedure of the test was as follows:
(1) the voltage breakdown tester was powered up to preheat for 15 min;
(2) the door of the apparatus was opened, and a thin film sample was placed between two electrodes, and the door of the apparatus was closed;
(3) the parameters were set on a tester software to start the test; and
(4) a voltage curve and a breakdown voltage value were output by an instrument software program.

### 4. Measurement of Gas Permeability of Thin Film

The gas permeability of a thin film was measured using a differential pressure method-based gas permeability tester (Labthink, VAC-V2):
(1) a thin film sample was cut, and the thickness thereof was measured;
(2) the test bench was coated with a layer of vacuum grease; if the grease is applied onto a disc in the cavity, it should be carefully wiped off; and if there is grease on the edge of a filter paper, the filter paper should be replaced (a filter paper for chemical analysis, with a thickness of 0.2-0.3 mm);
(3) the needle valves of a gas-permeable chamber were closed, and a vacuum pump was powered up;
(4) the filter paper was placed on the disc in the test bench, and a sample after state adjustment was then placed thereon; the sample should be kept flat without wrinkles; a gentle press was given so that the sample was in good contact with the vacuum grease on the test bench; the needle valve of a low-pressure chamber was opened, and the sample should be closely affixed to the filter paper under vacuum; and an O-ring was embedded in the groove of the upper cover, and the upper cover was put on and fastened;
(5) a needle valve and block valve of a high-pressure chamber were opened, and vacuuming was started until the pressure was 27 Pa or lower, and then degassing continued for 3 h or longer to remove the gas and water vapor adsorbed by the sample;
(6) the block valve was closed, a test gas cylinder was opened, and a gas source switch was turned on to fill the high-pressure chamber with test gas, making the gas pressure in the high-pressure chamber in a range of (1.0-1.1)×10⁵ Pa; when the pressure was too high, the block valve should be opened for pressure discharge;
(7) the power switch of the host and computer were turned on, the name and thicknesses of the samples on the test benches, the volume parameter of the low-pressure chamber, and the name of the test gas were respectively entered using a keyboard, making it ready for the test;
(8) the vent needle valves of the high-pressure and low-pressure chambers were closed to start the gas permeability test;
(9) in order to eliminate the non-linear stage at the beginning of the test, a pre-gas permeability test should be conducted for 10 min; and a formal gas permeability test was then started, and the pressure change value ΔP of the low-pressure chamber and the test time t were recorded; and
(10) the test continued until the change in pressure difference remained constant in an identical time interval, achieving a stable permeation; and the differential pressure values for at least 3 consecutive time intervals were taken to calculate the arithmetic average thereof, so as to calculate the gas permeation and the gas permeability of this sample.

### 5. Measurement of Temperature Stability of Thin Film

The temperature stability of a thin film was tested using a thin-film thermal shrinkage tester (Saicheng Instrument, RSY-01):
(1) a thin film sample of 15 mm*130 mm was cut, and holes were punched at both ends of the sample, with a hole spacing of 100 mm and a hole diameter of 5 mm;
(2) the sample was held through the fixtures at both ends of the tester to ensure the flatness of the sample;
(3) the tester was powered up, and the temperature was set to 100° C. to start heating; and
(4) the shrinkage rate of the thin film at 100° C. was output by the tester, with less than 0.8% being considered acceptable.

### 6. Test of Adhesive Force of Chip Substrate

The adhesive force of a chip substrate was measured using an HANDPI universal tensile tester:
(1) the thin film of the film-coated chip substrate was peeled off from the short side, making same perpendicular to the chip substrate, and then the thin film was clamped between the fixtures of the tester, and the screw was tightened to fix the thin film;
(2) the tester was lowered until the chip substrate was in contact with the test platform;
(3) the chip substrate was fixed on the test platform using a fixture; and
(4) the tester was powered up, with the output tensile peak value being the adhesive force of the chip substrate.

### 7. Parameter Measurement of Sliding Angle of Thin Film

The sliding angle of a thin film was measured using a sliding angle measuring instrument (SINDIN, SDC-350) to characterize the hydrophilicity of the hydrophilic surface and the hydrophobicity of the hydrophobic surface of the thin film. 60 pieces of the thin films were tested, and the procedure of the test was as follows:
(1) a film-coated chip substrate was placed on a test platform;
(2) the measuring instrument was powered up, and 10 μm of pure water was dripped at a measurement position to start the test; and
(3) the measurement software ran automatically, outputting a sliding angle value.

### Experimental Results and Discussion

TABLE 1
Statistical table of data on hydrophilicity and
hydrophobicity of thin films of Examples 1-3

| | |
|---|---|
| Hydrophobic surface | Hydrophilic surface |

Statistical table of measurement data on hydrophilicity
and hydrophobicity of FEP thin film 1 of Example 1

| | | | | | | | | | | | | |
|---|---|---|---|---|---|---|---|---|---|---|---|---|
| Sliding angle (°) | 10 | 11 | 12 | 13 | 14 | 15 | 30 | 31 | 32 | 33 | 34 | 35 |
| Number/Pcs | 1 | 4 | 3 | 18 | 22 | 12 | 10 | 8 | 16 | 15 | 4 | 7 |
| Contact angle (°) | 105 | 106 | 107 | 108 | 109 | 110 | 70 | 71 | 72 | 73 | 74 | 75 |
| Number/Pcs | 19 | 14 | 13 | 5 | 8 | 1 | 22 | 17 | 8 | 9 | 3 | 1 |

Statistical table of measurement data on hydrophilicity
and hydrophobicity of PFA thin film 2 of Example 2

| | | | | | | | | | | | | |
|---|---|---|---|---|---|---|---|---|---|---|---|---|
| Sliding angle (°) | 10 | 11 | 12 | 13 | 14 | 15 | 30 | 31 | 32 | 33 | 34 | 35 |
| Number/Pcs | 3 | 1 | 15 | 22 | 11 | 8 | 5 | 10 | 23 | 9 | 12 | 1 |
| Contact angle (°) | 105 | 106 | 107 | 108 | 109 | 110 | 70 | 71 | 72 | 73 | 74 | 75 |
| Number/Pcs | 7 | 19 | 16 | 9 | 4 | 5 | 15 | 23 | 10 | 7 | 3 | 2 |

Statistical table of measurement data on hydrophilicity
and hydrophobicity of FEP thin film 3 of Example 3

| | | | | | | | | | | | | |
|---|---|---|---|---|---|---|---|---|---|---|---|---|
| Sliding angle (°) | 10 | 11 | 12 | 13 | 14 | 15 | 30 | 31 | 32 | 33 | 34 | 35 |
| Number/Pcs | 5 | 10 | 8 | 21 | 12 | 4 | 8 | 5 | 19 | 16 | 7 | 5 |
| Contact angle (°) | 105 | 106 | 107 | 108 | 109 | 110 | 70 | 71 | 72 | 73 | 74 | 75 |
| Number/Pcs | 7 | 17 | 14 | 10 | 12 | 0 | 15 | 15 | 14 | 12 | 1 | 3 |

TABLE 2
Table of performance test parameters in Examples 4-6 and Comparative Examples 2-3

| | | | | Comparative | Comparative |
|---|---|---|---|---|---|
| | Example 4 | Example 5 | Example 6 | Example 2 | Example 3 |
| Type of thin film | FEP | PFA | FEP | FEP | PFA |
| Thickness of thin film (μm) | 12.5 | 12.5 | 25 | 12.5 | 12.5 |
| Hydrophilization treatment | Yes | Yes | Yes | No | No |
| Dielectric constant of film | 2.0 | 2.0 | 4.0 | 2.0 | 2.0 |
| Breakdown voltage of film | 260 | 260 | 400 | 260 | 260 |
| (kv/mm) | | | | | |
| Gas permeability of film | 11.6*10³ | 6.7*10³ | 5.3*10³ | 11.6*10³ | 6.7*10³ |
| (oxygen, cm³/m² * 24 | | | | | |
| hr*atm^{c}) | | | | | |
| Temperature stability (° C.) | 100 | 100 | 100 | 100 | 100 |

As can be seen from Table 1 and Table 2, the thin films of Examples 1-3 have a better dielectric constant, and the hydrophobic surfaces thereof have a larger contact angle, achieving a dual function of a dielectric layer and a hydrophobic layer in conventional processes. Additionally, the thin films of Examples 1-3 have a higher breakdown voltage, better gas permeability, and better temperature stability, with no wrinkle at a high-temperature condition of 100° C., and are therefore widely applicable in various environments.

As can be seen from Comparative Example 1, for a conventional chip with a dielectric layer and a hydrophobic layer, the hydrophobic layer easily falls off from the dielectric layer; however, no partial fall-off is observed on the chip prepared by using the thin film of the present application. Therefore, the thin film of the present application radically solves the problem of irreversible damage to a digital microfluidic chip caused by the easy fall-off of the hydrophobic layer from the dielectric layer. Additionally, the present preparation method of a chip substrate is simple compared to conventional complicated preparation processes.

As can be seen from Table 1, the corona-treated surface of the thin film has a sliding angle of 30°-35° and a contact angle of 70°-75°, thus having hydrophilicity. As can be seen from Examples 4-6 and Comparative Examples 2-3, the thin films after hydrophilization treatment in Examples 4-6 have a higher adhesive force to the circuit substrates, can be firmly affixed to the upper surface of the circuit substrate, do not easily fall off from the circuit substrate, and do not easily fall off from the circuit substrate even after being soaked in solvents during the use of digital microfluidic chips, thus prolonging the service life of chips.

1. A thin film, wherein the thin film is a dielectric and hydrophobic thin film, one surface of the dielectric and hydrophobic thin film being a hydrophilic surface and the other surface being a hydrophobic surface.

2. The thin film of claim 1, wherein the hydrophilic surface of the thin film has a contact angle of <90°.

3. The thin film of claim 1, wherein the hydrophilic surface of the thin film has a sliding angle of ≥30°.

4. The thin film of claim 1, wherein the dielectric and hydrophobic thin film is a Teflon thin film.

5. The thin film of claim 4, wherein the thin film is an amorphous fluoropolymer thin film, a fluorinated ethylene propylene resin thin film, a fluoropolymer foam resin thin film, a fluoropolymer resin thin film, or a perfluoroalkoxy resin thin film.

6. The thin film of claim 4, wherein the thin film is a fluorinated ethylene propylene resin thin film or a perfluoroalkoxy resin thin film.

7. The thin film of claim 1, wherein the thin film has a thickness of 5-200 μm.

8. The thin film of claim 7, wherein the thickness of the thin film is 10-100 μm.

9. The thin film of claim 8, wherein the thickness of the thin film is 12.5-25 μm.

10. The thin film of claim 9, wherein the thickness of the thin film is 12.5 μm or 25 μm.

11. A digital microfluidic chip substrate, wherein the chip substrate comprises a circuit substrate, an adhesive, and the thin film of claim 1.

12. The digital microfluidic chip substrate of claim 11, wherein the circuit substrate and the thin film are bonded by the adhesive, and the adhesive is bonded to the hydrophilic surface of the thin film.

13. The digital microfluidic chip substrate of claim 11, wherein the adhesive is one or more of polyacrylic acid, polyurethane, epoxy resin, polyimide, polystyrene, polyacrylates, or ethylene-vinyl acetate copolymer.

14. A method for preparing the thin film of claim 1, wherein the method comprises subjecting the thin film to surface modification treatment.

15. The method of claim 14, wherein the thin film is subjected to surface modification treatment to obtain the hydrophilic surface, and the hydrophilic surface has a contact angle of <90°.

16. The method of claim 14, wherein the thin film is subjected to surface modification treatment to obtain the hydrophilic surface, and the hydrophilic surface has a contact angle of ≥30°.

17. The method of claim 14, wherein the surface modification treatment is corona treatment, plasma treatment, chemical treatment, surface grafting treatment, or photochemical modification treatment.

18. The method of claim 14, wherein the surface modification treatment is corona treatment.

19. A method for preparing the digital microfluidic chip substrate of claim 11, wherein the method comprises:
(1) applying the adhesive to a surface of the circuit substrate;
(2) covering the surface of the adhesive with the hydrophilic surface of the thin film.

20. The method of claim 19, wherein the method further comprises, in step (2), covering the hydrophobic surface of the thin film with a protective film.

21. The method of claim 19, wherein the method further comprises:
(3) processing the thin film on the surface of the circuit substrate in step (2) to obtain a desired shape;
(4) removing the protective film, so as to obtain the digital microfluidic chip substrate.

22. (canceled)

23. A digital microfluidic chip, wherein the digital microfluidic chip comprises the thin film of claim 1.

24. A digital microfluidic system, wherein the digital microfluidic system comprises the thin film of claim 1.
